(19) United States
(12) Patent Application Publication
(10) Pub. No.: US 2007/0119666 A1
(43) Pub. Date: May 31, 2007

(54) Support bracket for an internally abutted brake pad and a hanging brake pad

(76) Inventors: Manuel Barbosa, Novi, MI (US); Seiji Nishimura, Saitama Prefecture (JP); Sean C. Barrett, Farmington, MI (US)

Correspondence Address: HARNESS, DICKEY & PIERCE, P.L.C., P.O. BOX 828, BLOOMFIELD HILLS, MI, 48303, US

(21) Appl. No.: 11/288,036

(22) Filed: Nov. 28, 2005

(51) Int. Cl. F16D 65/14

(52) U.S. Cl. 188/73.46

(57) ABSTRACT

A brake assembly generally includes a hanging brake pad, an abutted brake pad and a caliper body that clamps the pads against a rotor. The brake system comprises a support bracket having a first portion and a second portion. The first portion defines an aperture that receives the abutted brake pad. The second portion extends generally perpendicular from the first portion. At least one rail extends from the second portion. The at least one rail receives the hanging brake pad and wherein the support bracket is adapted to connect to the caliper body.

### CROSS-REFERENCE TO RELATED APPLICATIONS

This application relates to U.S. patent application Ser. No. [XX/XXX,XXX] filed on [______ ] titled Outer Pad Abutment Design for Frame Type Calipers, Attorney Docket No. 2448-000031. The above disclosure is hereby incorporated by reference as if fully set forth herein.

### FIELD

The present teachings relate to a disc brake assembly and more specifically relate to a support bracket configured to receive both a hanging brake pad and an internally abutted brake pad.

### BACKGROUND

In one example, a support bracket includes a pair of rails and/or pins from which pair of hanging pads extend and slidably move toward a rotor. A pressure plate formed in a portion of the rails may serve as a tension member under a braking load. Because in some designs it may not be structurally necessary to cast an additional tension member into the support bracket, the overall size of the support bracket may be reduced.

In another example and with reference to FIG. 1, a caliper assembly 1 may have a support bracket 2, which may be configured to receive a pair of internally abutted brake pads 3. The support bracket 2 that receives the pair of internally abutted brake pads 3 tends to deflect under braking loads relatively less than the above-mentioned support bracket having the pair of rails and/or pins. In this regard, the support bracket 2 may include an outer beam tension member 4 to reduce the deflection under the braking load. The support brackets 2 that are configured to receive the pair of internally abutted brake pads 3 are, however, relatively larger and heavier than the above mentioned support bracket with the pair of rails and associated hanging pads.

### SUMMARY

The present teachings generally include a brake assembly having a hanging brake pad, an abutted brake pad and a caliper body that clamps the pads against a rotor. The brake system comprises a support bracket having a first portion and a second portion. The first portion defines an aperture that receives the abutted brake pad. The second portion extends generally perpendicular from the first portion. At least one rail extends from the second portion. The at least one rail receives the hanging brake pad and wherein the support bracket is adapted to connect to the caliper body.

Further areas of applicability of the present teachings will become apparent from the detailed description and the claims provided hereinafter. It should be understood that the specific examples in the detailed description, while indicating the various embodiments of the teachings, are intended for purposes of illustration only and are not intended to limit the scope of the present teachings.

### BRIEF DESCRIPTION OF THE DRAWINGS

The various embodiments of the present teachings will become more fully understood from the detailed description, the appended claims, and the accompanying drawings, wherein:

FIG. 1 is a prior art perspective view of a brake caliper assembly including a support bracket having an outer beam tension member configured to internally abut a pair of brake pads; and

FIGS. 2 and 3 are perspective views of a disc brake assembly showing a rotor received by a support bracket having an internally abutted brake pad and a hanging brake pad constructed in accordance with the present teachings;

FIG. 4 is a bottom view of the disc brake assembly of FIGS. 2 and 3;

FIG. 5 is a cross-sectional view of the disc brake assembly of FIG. 4 showing the caliper body in an unclamped or open position in accordance with the present teachings;

FIG. 6 is similar to FIG. 5 and shows the caliper in a clamped position;

FIG. 7A is a perspective view of the outboard side of the support bracket of FIGS. 2 and 3 in accordance with the present teachings;

FIG. 7B is a perspective view of the inboard side of the support bracket of FIG. 7A;

FIG. 8A is similar to FIG. 7A and shows a hanging brake pad connected to the support bracket in accordance with the present teachings;

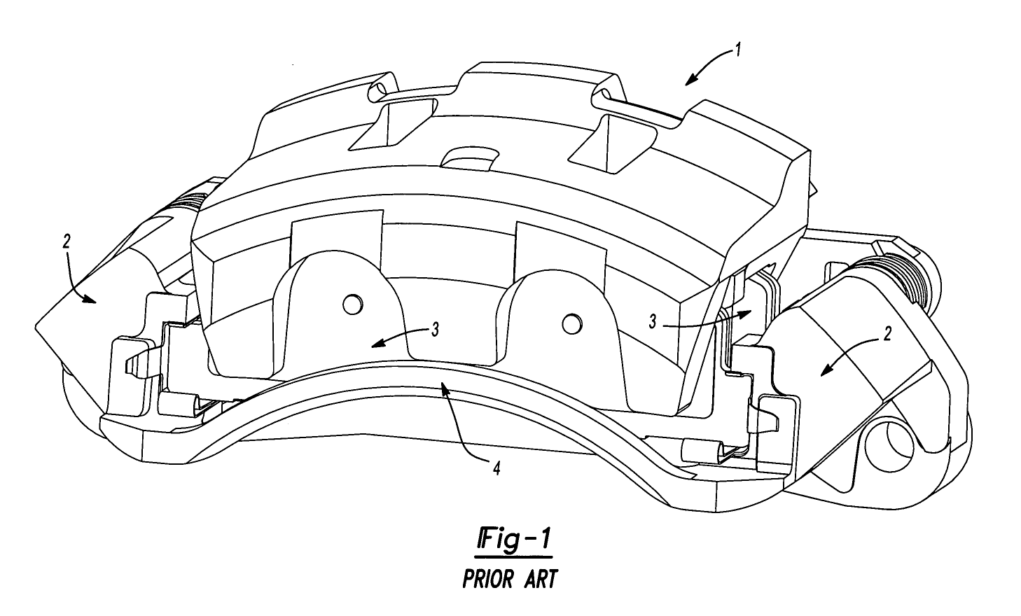

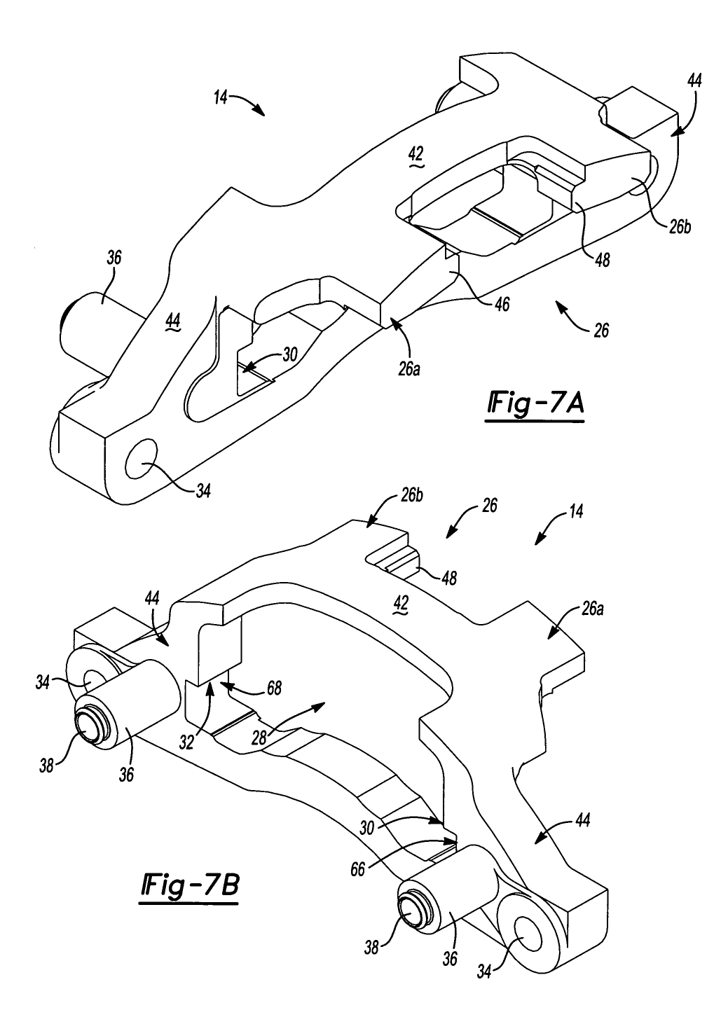

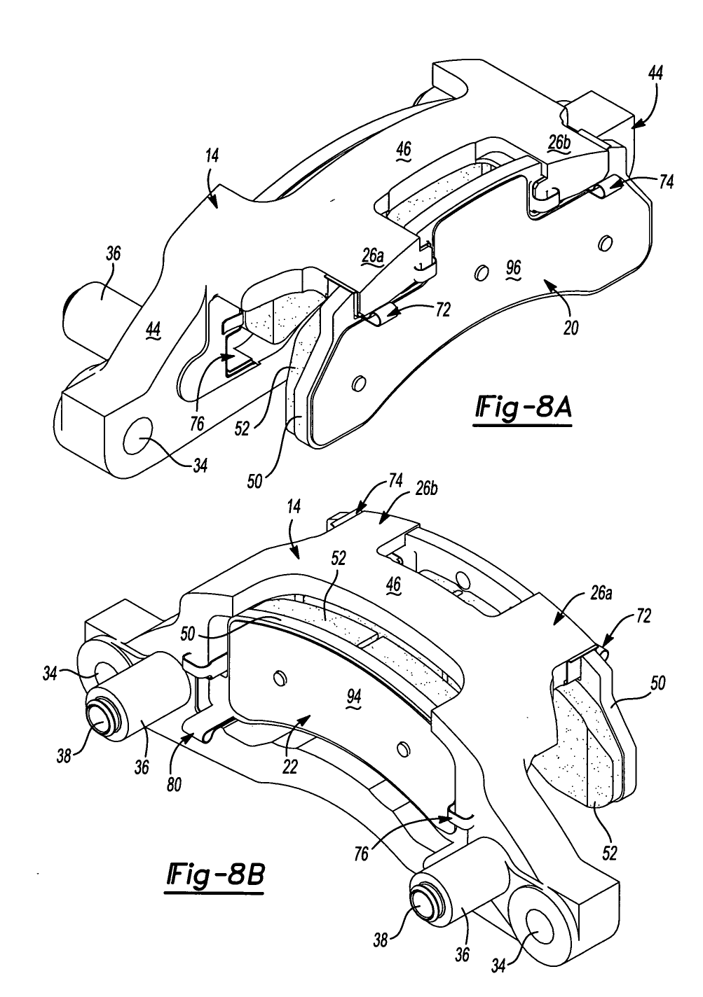

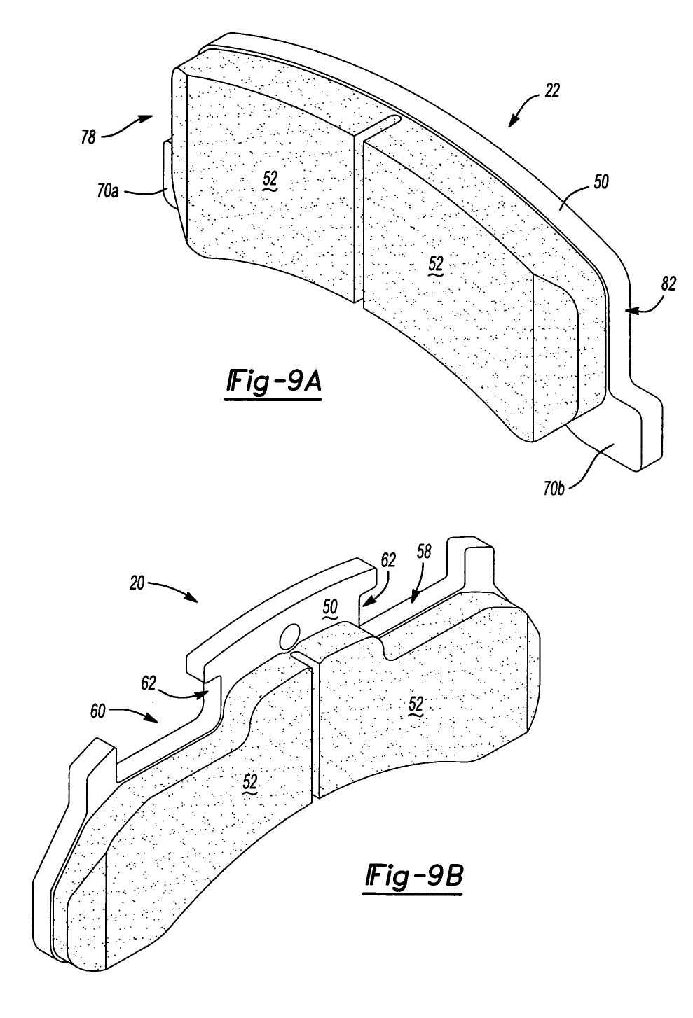

FIG. 7B is similar to FIG. 8B and shows the internally abutted brake pad held within the support bracket;

FIG. 9A is a perspective view of the internally abutted brake pad of FIG. 8B; and

FIG. 9B is a perspective view of the hanging pad of FIG. 8A.

### DETAILED DESCRIPTION OF THE VARIOUS EMBODIMENTS

The following description of the various embodiments is merely exemplary in nature and is in no way intended to limit the teachings, their application, or uses.

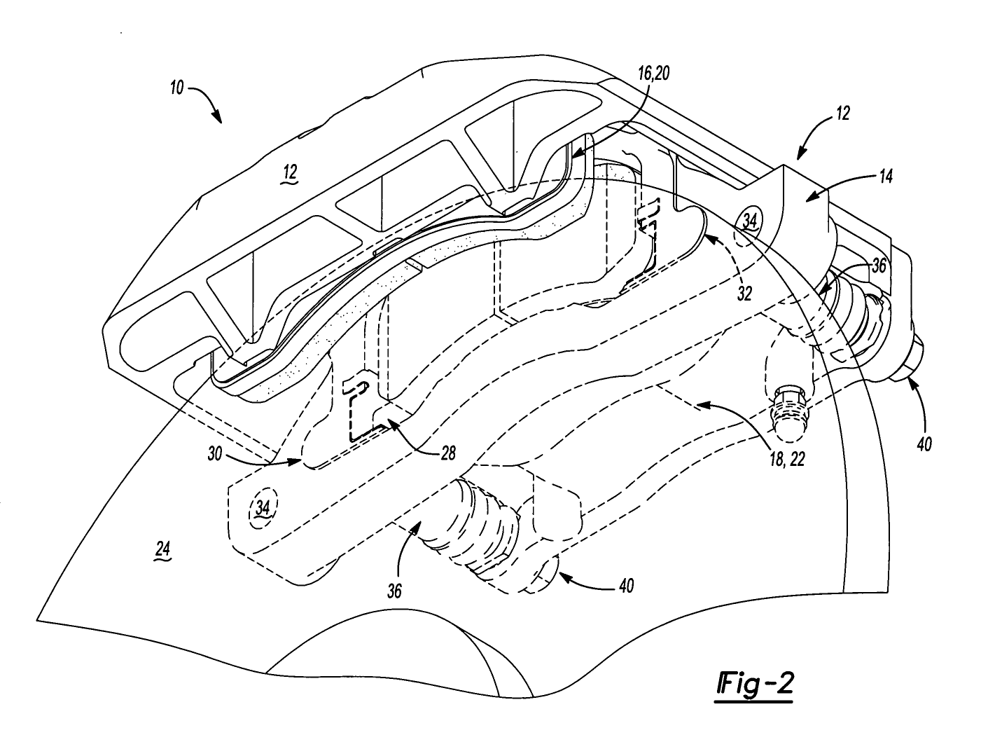

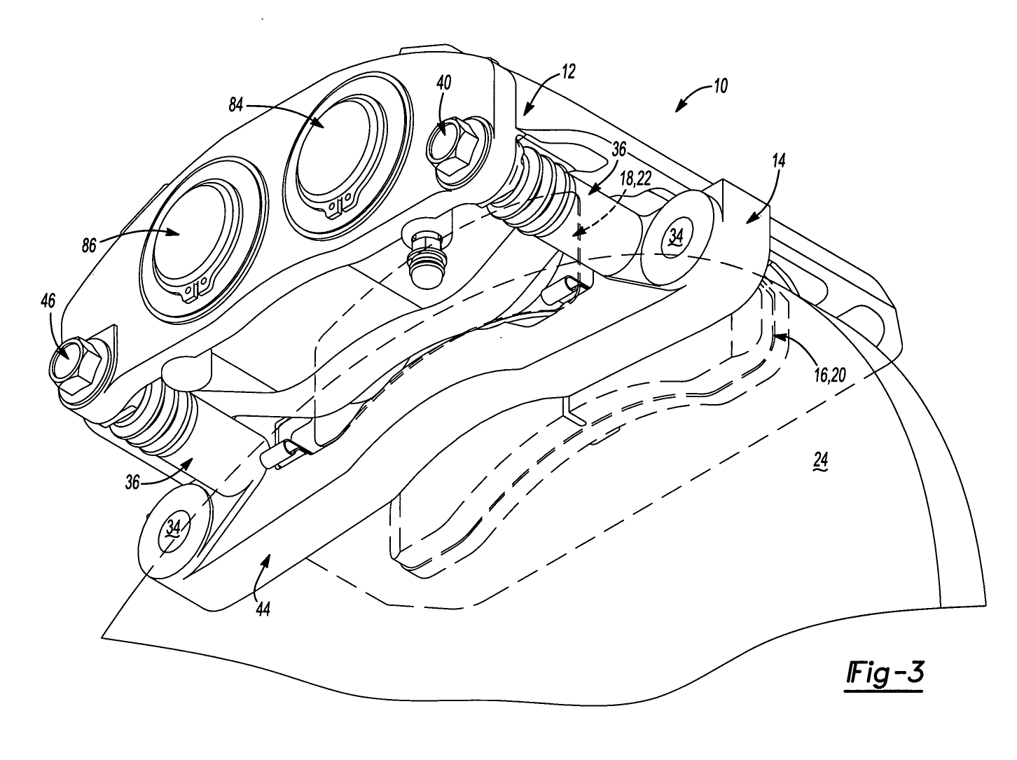

The present teachings generally include a disc brake system 10. While the present teachings are generally described and illustrated with reference to a vehicle and an exemplary associated suspension and drive train, the present teachings remain applicable in various applications to aid in slowing of rotating motion. With reference to FIGS. 2 and 3, the disc brake assembly 10 includes a caliper body 12, a support bracket 14, an outboard brake pad 16 and an inboard brake pad 18. In one example, the support bracket 14 is configured to receive a hanging brake pad 20 and an internally abutted brake pad 22. In this regard, the outboard brake pad 16 may define the hanging brake pad 20, while the inboard brake pad 18 may define the internally abutted brake pad 22. In other examples, the position of the brake pads may be reversed. The caliper body 12 may connect to the support bracket 14 and be moveable relative thereto when clamping the brake pads 16, 18 against a rotor 24 to slow the motion of a vehicle (not shown).

The support bracket 14 may define hanging rails 26 (FIGS. 7A and 7B) and an aperture 28. The aperture 28 may serve as an internal abutment portion for the internally abutted brake pad 22. The hanging rails 26 may include a front rail 26a and rear rail 26b from which the hanging brake pad 20 may be coupled. With regard to abutting the brake pad 22, the aperture 28 may define a front abutment portion 30 and a rear abutment portion 32 that receive (i.e. abut) the internally abutted brake pad 22.

The support bracket 14 may also define two mounting holes 34. The mounting holes 34 may facilitate coupling the support bracket 14 locations on the vehicle (not shown) using various suitable methods. The support bracket 14 may further define two mounting bosses 36 in which an aperture 38 (FIG. 7B) is formed. A fastener 40 may couple the caliper body 12 to the support bracket 14 via the aperture 38 on the mounting boss 36 and further allow the caliper body 12 to move relative to the support bracket 14 when clamping against the rotor 24. In this regard, the support bracket 14 remains fixed with the vehicle and the caliper body 12 moves relative to the rotor 24.

In one example and with reference to FIGS. 7A and 7B, the support bracket 14 is a single piece of material, i.e., monolithic. For example, the support bracket 14 may be made from a single casting. The support bracket 14 may define a bridging portion 42 that extends over the rotor 24. The bridging portion 42 may extend in a generally perpendicular direction from a generally planar portion 44 of the support bracket 14. The hanging rails 26 may extend from the bridging portion 42. In this regard, the planar portion 44 may define the aperture 28 that receives (i.e., abuts) the internally abutted brake pad 22, while the hanging rails 26 can hold the hanging brake pad 20.

With regard to the hanging rails 26, the front rail 26a includes a protrusion 46 that may face the rear rail 26b. The rear rail 26b includes a protrusion 48 that may face the front rail 26a. With reference to FIGS. 9A and 9B, the brake pads 20, 22 include a backing member 50 and a friction material 52. With reference to FIG. 8B and FIG. 9B, the backing member 50 defines a front rail channel 58 and a rear rail channel 60. The rail channels 58, 60 further define respective grooves 62. In one example, the grooves 62 may be formed on inside walls of the rail channels 58, 60. When the hanging brake pad 20 is received by (and hangs from) the rails 26, the protrusions 46, 48 are received by the grooves 62 and thus hold the brake pad 20 to the rails 26. When the caliper body 12 clamps the brake pads 20, 22 against the rotor 24, the hanging brake pad 20 travels along the rails 26, thus contacting the rotor 24 with the friction material 52 to slow the vehicle.

With reference to FIGS. 7B and 8B, the support bracket 14 defines the aperture 28 that receives and abuts the internally abutted brake pad 22. The front abutment portion 30 may define a front channel 66 and the rear abutment portion 32 may define a rear channel 68. The backing member 50 of the internally abutted brake pad 22 may define a pair of flanges 70 (FIG. 9A) that is received in the front channel 66 and the rear channel 68, respectively. More specifically, a front flange 70a (FIGS. 9A) may abut the front channel 66 formed in the front abutment portion 30 during a braking load, i.e., when the vehicle is slowed in a forward direction. A rear flange 70b (FIG. 9A) may similarly abut the rear channel 68 formed in the rear abutment portion 32 during an opposite braking load i.e., when the vehicle is slowed in a rearward direction. It will be appreciated that the internally abutted brake pad 22 is held within the aperture 28 while no braking load is supplied.

In one example and with reference to 8A and 9B, a front rail clip 72 may be disposed between the front rail 26a and the front rail channel 58. A rear rail clip 74 may be disposed between the rear rail 26b and the rear rail channel 60. With reference to FIGS. 8B and 9A, a front abutment clip 76 may be disposed between the front abutment portion 30 and a front side 78 of the internally abutted brake pad 22. The front side 78 of the brake pad 22 may further define the aforementioned front flange 70a. A rear abutment clip 80 may be disposed between the rear abutment portion 32 and a rear side 82 of the internally abutted brake pad 22. The rear side 82 of the brake pad 22 may define the aforementioned rear flange 70b.

It may be shown that one or more of the clips 72, 74, 76, 80 may reduce the friction between the above-mentioned portions and structures of the support bracket 14 and the pads 20, 22 between which the clips 72, 74, 76, 80 are respectively disposed relative to contact therebetween without the clips 72, 74, 76, 80. Moreover, it may be shown that the clips 72, 74, 76, 80 position and provide tension between the internally abutted brake pad 22, the aperture 28, the rails 26 and rail channels 66, 68. The tension between the pads 20, 22 and the support bracket 14 may be shown to reduce noise, vibration or harshness in the disc brake assembly 10.

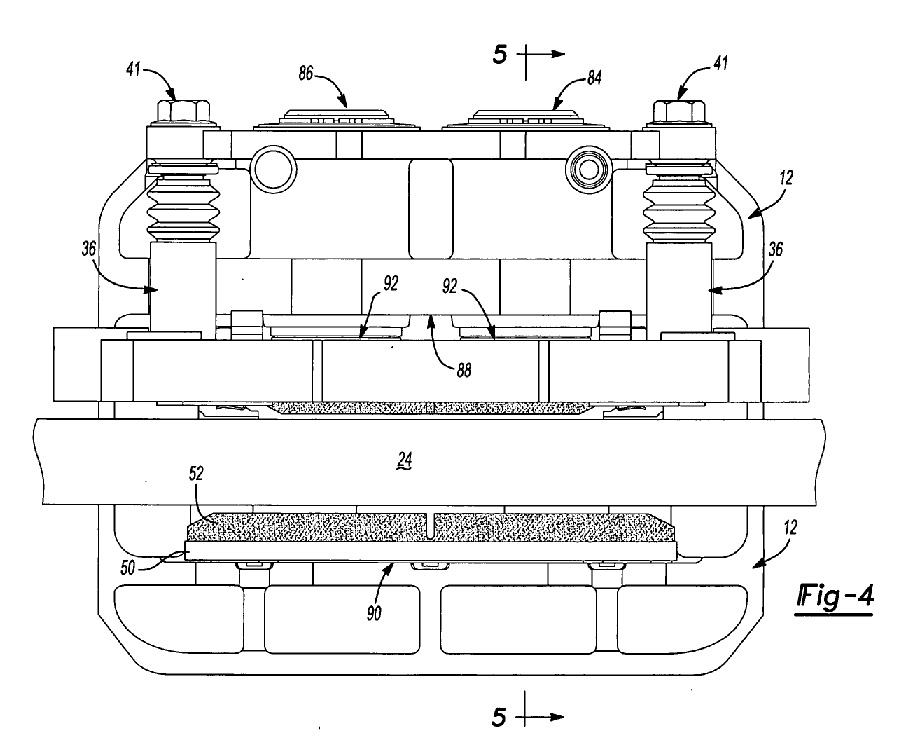

With reference to FIGS. 2, 3 and 4, the caliper body 12 includes a first piston 84, a second piston 86, an inboard contact surface 88 and an outboard contact surface 90. The pistons 84, 86 may be formed on (and behind) the inboard contact surface 88. The outboard contact surface 90 is about opposite to the inboard contact surface 88, i.e., on opposite sides of the rotor 24. A face 92 of each piston 84, 86 contacts the backing member 50 of the inboard brake pad 18 (illustrated as the internally abutted brake pad 22).

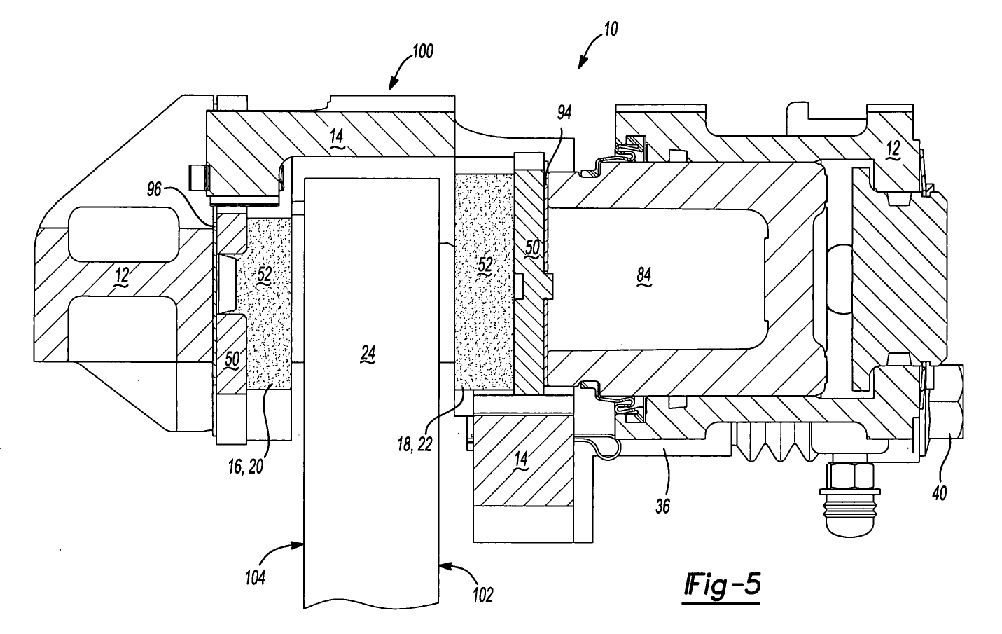

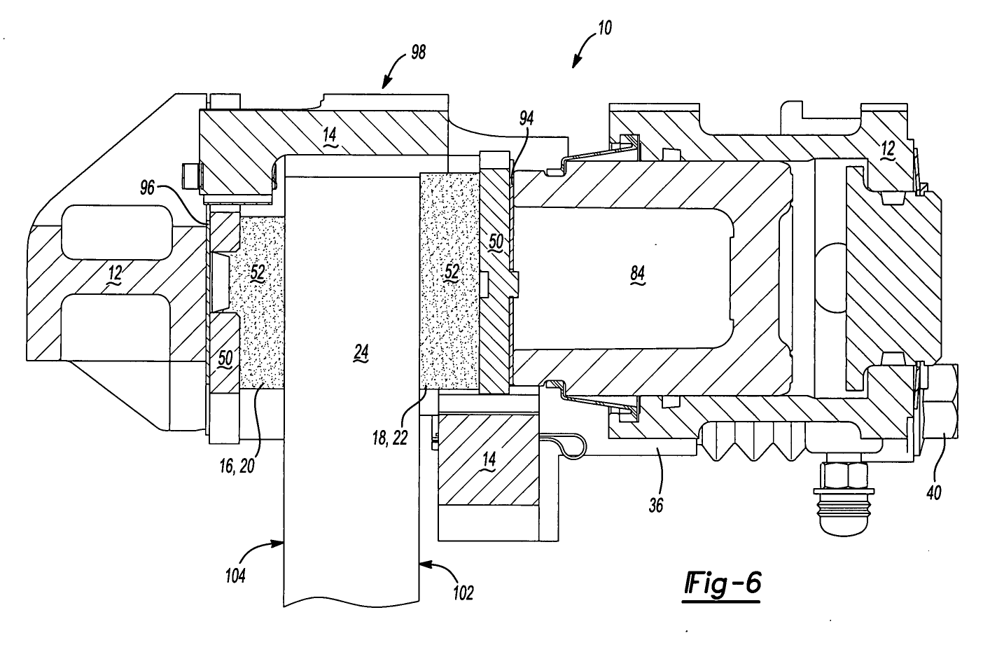

An inboard shim 94 may be placed between the inboard brake pad 18 and the faces 92 of the pistons 84, 86 respectively. It will be appreciated when the pistons 84, 86 are fully retracted (i.e., flush or recessed with the caliper body 12), the inboard shim 94 (FIGS. 5 and 6) may contact the outboard contact surface 90. The outboard contact surface 90 may abut the backing member 50 of the outboard brake pad 16 (illustrated as the hanging pad 20). An outboard shim 96 (FIGS. 5 and 6) may be placed between the outboard brake pad 16 and the outboard contact surface 90 of the caliper body 12. The caliper body 12 may also include a suitable hydraulic valve that may allow for addition, removal and/or maintenance of a hydraulic fluid within the first and second pistons 84, 86.

In operation and with reference to FIGS. 5 and 6, the pistons 84, 86 may be extended and retracted by manipulating the hydraulic fluid pressure in the caliper body 12. By increasing the hydraulic fluid pressure to the pistons 84, 86, the pistons 84, 86 extend out of the caliper body 12 and define an extended or clamping position 98. By reducing the hydraulic pressure to the pistons 84, 86, the pistons 84, 86 retreat into the caliper body 12 and define an unclamped or retracted position 100. In the clamped position 98, the faces 92 of the respective pistons 84, 86 urge the inboard brake pad 18 toward an inboard face 102 of the rotor 24. The caliper body 12 also moves relative to the support bracket 14 and the rotor 24 and therefore urges the outboard brake pad 16 toward an outboard face 104 of the rotor 24. The friction material 52 on the inboard and the outboard brake pads 16, 18 contact the faces 102, 104 of the rotor 24. The pistons 84, 86 may continue to urge the pads 16, 18 against the rotor 24, thereby clamping the rotor 24 and reducing its rotational velocity to thereby slow the vehicle. By contacting the rotor 24, the friction material 52 on the brake pads 20, 22 wear due to the heat and abrasion while engaging the rotor 24.

Those skilled in the art can now appreciate from the foregoing description that the broad teachings may be implemented in a variety of forms. Therefore, while the present teachings have been described in connection with the specific examples thereof, the true scope of the present teachings should not be so limited because other modifications will become apparent upon a study of the drawings, the specification, and the following claims.

What is claimed is:

1. A brake assembly including a hanging brake pad, an abutted brake pad and a caliper body that clamps the pads against a rotor, the brake assembly comprising:
a support bracket having a first portion and a second portion, said first portion defining an aperture that receives the abutted brake pad, said second portion extending generally perpendicular from said first portion; and
at least one rail that extends from said second portion, said at least one rail receives the hanging brake pad, wherein said support bracket is adapted to connect to the caliper body.

2. The brake assembly of claim 1 wherein the support bracket is a unitary construction.

3. The brake assembly of claim 1 wherein a portion of said second portion of said support bracket is disposed above the rotor.

4. The brake assembly of claim 1 wherein at least one rail includes a first rail and a second rail, said first rail and said second rail hold the hanging brake pad such that the hanging brake pad moves relative to said first rail and said second rail.

5. The brake assembly of claim 4 further comprising at least one of a first protrusion that extends from said first rail toward said second rail; and a second protrusion that extends from said second rail toward said first rail.

6. The brake assembly of claim 4 further comprising a plurality of clips, wherein at least one of a first clip is between said first rail and the hanging brake pad, a second clip is between said second rail and the hanging brake pad, a third clip and a fourth clip are between the abutted brake pad and said aperture.

7. A brake assembly including a caliper body that clamps against a rotor, the brake assembly comprising:
a hanging brake pad;
an internally abutted brake pad;
a support bracket having a first portion and a second portion, said first portion defining an aperture that receives said internally-abutted brake pad, said second portion extending from said first portion and at least partially over the rotor; and
a pair of rails that extend from said second portion, said pair of rails hold said hanging brake pad, wherein said support bracket is adapted to connect to the caliper body such that the caliper body clamps said hanging brake pad and said internally abutted brake pad against the rotor.

8. The brake assembly of claim 7 wherein said support bracket is a unitary construction.

9. The brake assembly of claim 7 further comprising at least one of a first protrusion that extends from a first rail of said pair of rails toward a second rail of said pair of rails and a second protrusion that extends from said second rail toward said first rail.

10. The brake assembly of claim 7 further comprising a plurality of clips, wherein at least one of a first clip is between a first rail of said pair of rails and said hanging brake pad, a second clip is between a second rail of said pair of rails and said hanging brake pad, a third clip and a fourth clip are between said internally abutted brake pad and said aperture.

11. A support bracket for a brake assembly, the support bracket comprising
a planar portion having an aperture adapted to receive a brake pad;
a bridging portion that extends from said planar portion; and
a pair of rails that extend from said bridging portion adapted to hold a brake pad generally opposite the brake pad held within said aperture.

12. The support bracket of claim 11 wherein said planar portion, said bridging portion and said pair of rails are a unitary construction.

13. The support bracket of claim 11 wherein a portion of said bridging portion is adapted to be disposed above a rotor.

14. The support bracket of claim 11 further comprising at least one of a first protrusion that extends from a first rail of said pair of rails toward a second rail of said pair of rails; and a second protrusion that extends from said second rail toward said first rail.

15. The support bracket of claim 11 further comprising a plurality of clips, wherein at least one of a first clip is between a first rail of said pair of rails and said brake pad, a second clip is between a second rail of said pair of rails and said brake pad associated with said pair of rails, a third clip and a fourth clip are between said brake pad and said aperture.
